(19) United States
(12) Patent Application Publication
(10) Pub. No.: US 2004/0234106 A1
(43) Pub. Date: Nov. 25, 2004

(54) Method and apparatus for providing nanoscale dimensions to SEM (Scanning Electron Microscopy) or other nanoscopic images

(76) Inventors: Victor Van Luu, Morgan Hill, CA (US); Don Van Tran, Morgan Hill, CA (US)

Correspondence Address: TRAN & ASSOCIATES, 6768 MEADOW VISTA CT., SAN JOSE, CA, 95135, US

(21) Appl. No.: 10/638,693

(22) Filed: Aug. 10, 2003

Related U.S. Application Data
(60) Provisional application No. 60/473,364, filed on May 23, 2003.

(51) Int. Cl. G06K 9/00; G21K 7/00

(52) U.S. Cl. 382/106; 250/311

(57) ABSTRACT

Systems and methods are disclosed to determine dimensions of an imaged object: determining a scale factor for each pixel of the imaged object; receiving a dimensional specification between two or more points on the object; determining a pixel count between the two or more points; and determining the actual dimension of the object using the pixel count and scale factor.

This application claims priority from Provisional Application Serial No. 60/473,364, filed on May 23, 2003, the content of which is incorporated by reference.

This application is also related to application Ser. No. 10/______ entitled “SYSTEMS AND METHODS FOR CHARACTERIZING A SAMPLE” and Ser. No. 10/______ entitled “SYSTEMS AND METHODS FOR CHARACTERIZING A THREE-DIMENSIONAL SAMPLE”, all with common inventorship and common filing date, the contents of which are hereby incorporated by reference.

### BACKGROUND

The present invention relates to a method and apparatus for providing nano-scale dimension to a microscopic or SEM (Scanning Electron Microscopy) image.

Nanotechnology application has relied on scanning electron microscope to reveal object that is, typically, on the order of 100 nanometer or less. The result of this process is the capture of the SEM images that can be converted to the most common graphic interchange format, for example, GIF, JPEG, TIFF or other format. This enables the users to display the image with all common graphic display application. The interpretation of these images is typically done manually based on the scale provided when the images are captured during the scanning electron microscopy process. The manual operation requires the user to print the image out to a hard copy, use a ruler to calculate the dimensions, load the image back onto a graphic application like Paint from Microsoft, and manually annotate the dimensions without any help from the software.

This operation is very slow and prone to error, and it can be particularly annoying to the users who need to interpret the image quickly to solve problems in a real time production environment. Most of the scanning electron microscopes are housed on a very sensitive and dust free environment, which makes the communication very complex and slow among the technicians, who operate the microscopes, and the users, who need to interpret the data on the images quickly.

### SUMMARY

In one aspect, a method and an apparatus determine dimensions of an imaged object by determining a scale factor for each pixel of the imaged object; receiving two or more points associated with the object; determining a pixel count between the two or more points; and determining the actual dimension of the object using the pixel count and scale factor.

Implementations of the method and apparatus may provide for automatically calculating the nanodimensions of graphical entities including: lines; polylines; shapes such as rectangles, circles, eclipses or closed-polylines; solid objects as boxes, cylinders, cones or spheres; or other geometric objects in SEM images.

Advantages of the above system may include one or more of the following. The system provides ease-of-use, economical, precision and reliable desktop software measurement tool for precision nanoscale CD (Critical Dimension) Metrology. The system minimizes the labor intensive and imprecise process of manually measuring nano-scale objects of SEM images.

### BRIEF DESCRIPTION OF THE DRAWINGS

Embodiments of the invention will now be described with reference to the accompanying drawing, in which:

FIG. 1A shows an exemplary graphical application in which a SEM picture is loaded and displayed with the scale in nanometer taken during the scanning electron microscopy process.

FIG. 1B shows an exemplary graphical application in which a scale is converted to pixel with a vertical and horizontal ruler calibrated properly in nanometer.

FIG. 2 shows an exemplary graphical application in which a character recognition technique is used to capture the measurement.

FIG. 3 shows an exemplary graphical application in which a linear horizontal technique is used to annotate the dimension.

FIG. 4 shows an exemplary graphical application in which a linear vertical technique is used to annotate the dimension.

FIG. 5 shows an exemplary graphical application in which an aligned technique is used to annotate the dimension.

FIG. 6 shows an exemplary graphical application in which an angular technique is used to annotate the dimension.

FIG. 7 shows an exemplary graphical application in which a dimension technique is used to annotate the volume of a solid object in 2D.

FIG. 8 shows an exemplary graphical application in which a dimension technique is used to annotate the perimeter and area of a drawing rectangle.

FIG. 9 shows an exemplary graphical application in which a dimension technique is used to annotate the circumference, area, radius and diameter of a drawing circle.

FIG. 10 shows an exemplary graphical application in which an automated shape recognition technique is used to annotate the area, perimeter, width and length of highlighted shapes.

FIG. 11 shows an exemplary process for determining object dimension.

FIG. 12A illustrates an exemplary process to automatically select and characterize dimensions of objects, and FIG. 12B shows an exemplary operation of the process of FIG. 12A.

### DESCRIPTION

The present invention is described in terms of a graphical application operating within a graphical operating system, for example, Windows XP, NT or 2000 from Microsoft Corporation. In the context of the present invention, the areas of interest to the portion of the graphical application related to the conversion of the physical scale line (14)(15), using unit (16) as micron (10⁻⁶ meter), nanometer (10⁻⁹ meter) or angstrom (10⁻¹⁰ meter), but not limited to these units, embedded in the picture taken during the scanning electron microscopy process, to the basic unit of the composition of an image on computer monitor or similar display, called pixel.

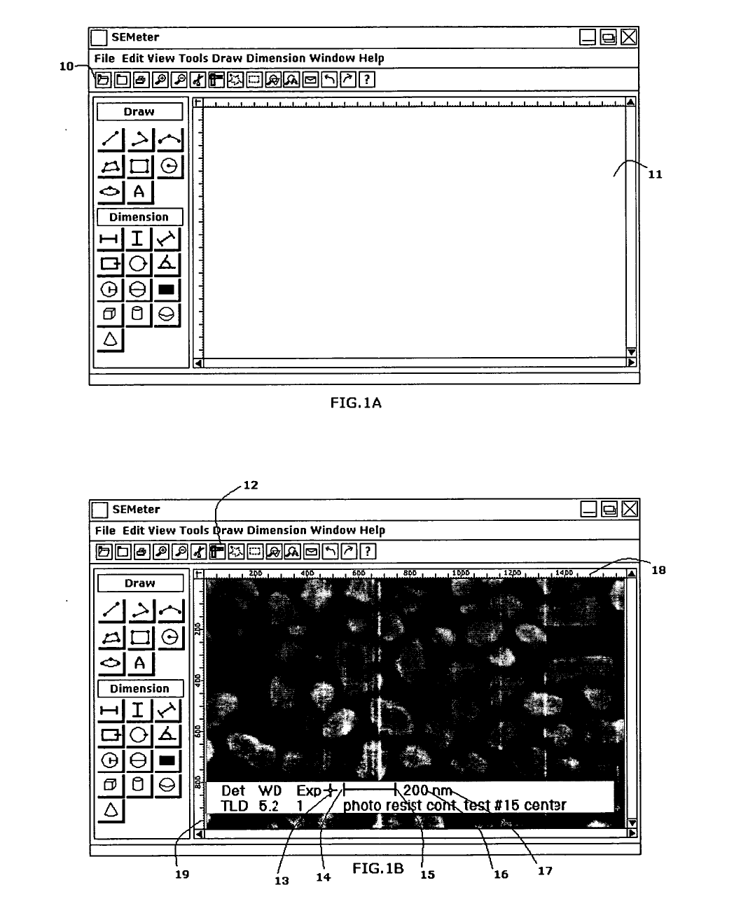

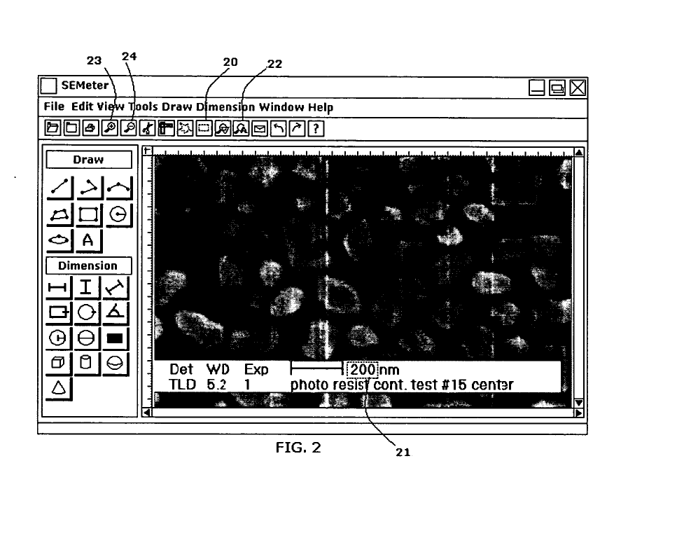

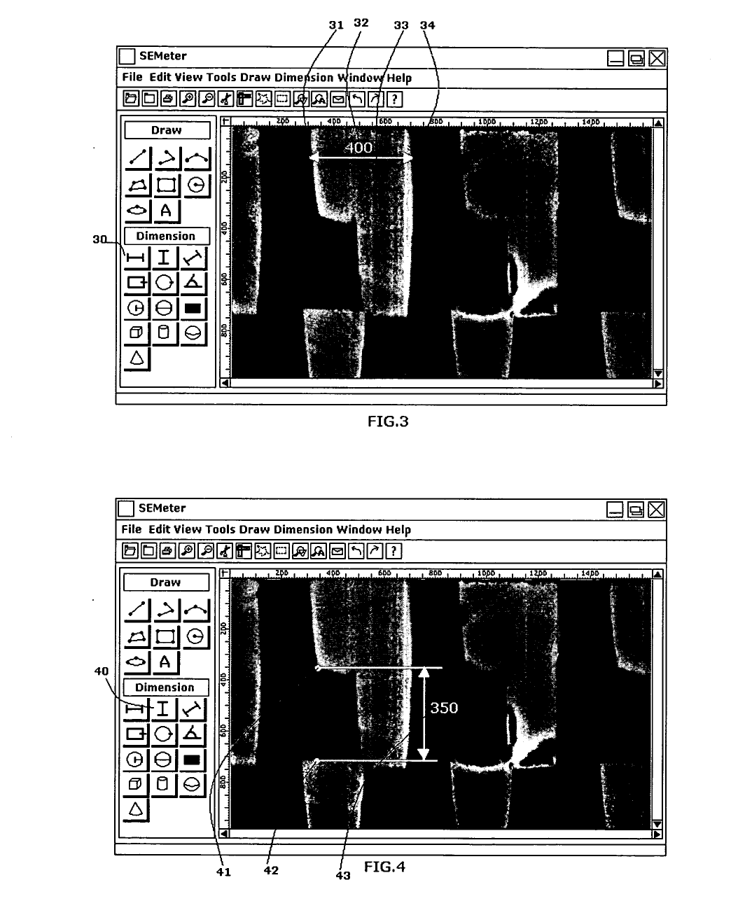

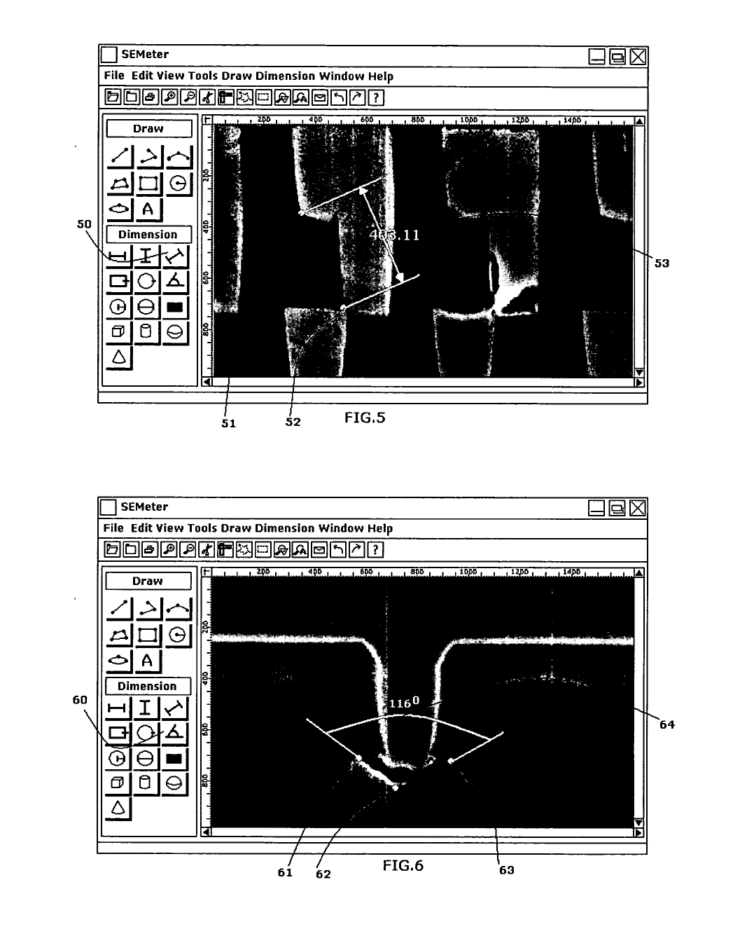

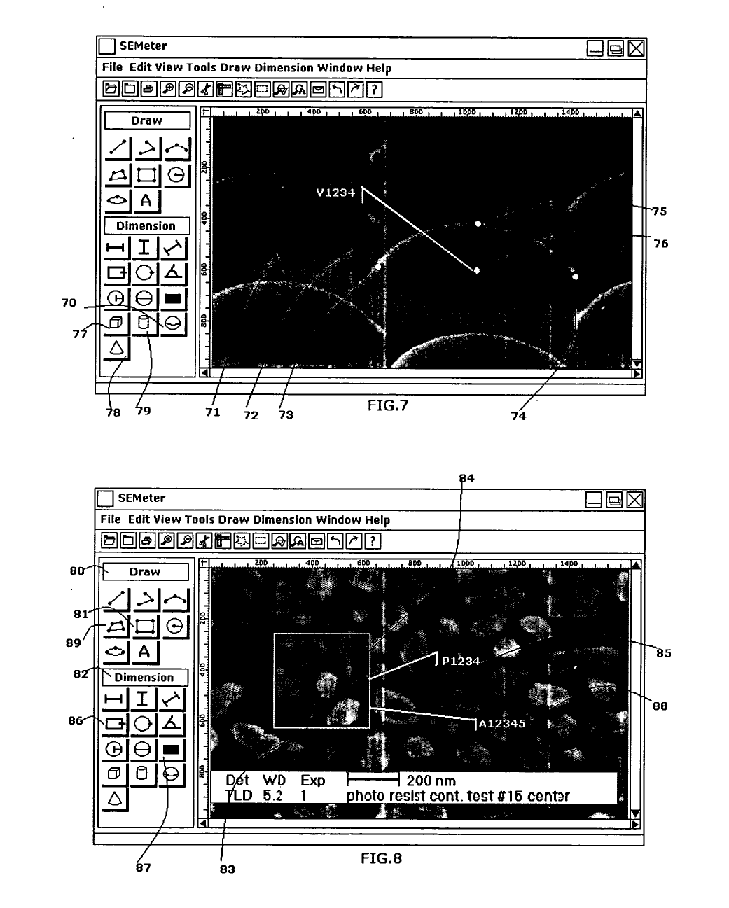

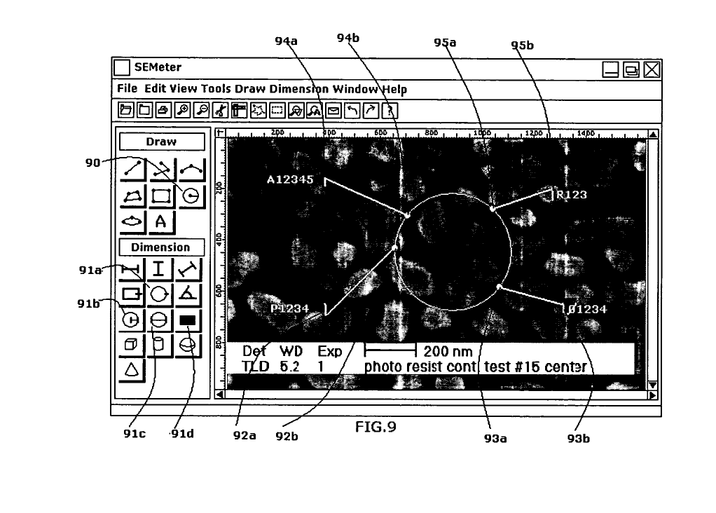

When the user decides to create dimension for the nano-object in the SEM image, the image file is loaded into the graphical application (FIG. 1A). The mouse pointer is moved to an icon (10) that indicating an image file is to be selected and opened (11). The first operation the user wants to perform which will be to calibrate or convert the scale, normally in nanometer, attached to the picture (16), to pixel for display and on-screen calculation. For this operation, the mouse pointer is moved to icon (12) and clicked, and the cursor on the screen becomes a shape of a crosshair (13).

In the first step, the user chooses the following options to convert the line scale to pixel:

1. Move the crosshair to the beginning of the scale (14) and click on the left button of the mouse, and the application will respond automatically with a message describing the number of pixel calculated from the scale line, from (14) to (15). In one embodiment, the application will highlight the scale line with a different color when the operation is successful.

2. Move the crosshair to the beginning of the scale (14) and left click at the mouse. Move the crosshair to the end of the scale (15) and right click at the mouse to finish this option, and the application will respond automatically with a message describing the number of pixel calculated from the scale line, from (14) to (15). In one implementation, the application will highlight the scale line with a different color when the operation is successful.

3. Move the crosshair to the beginning of the scale (14), hold the left mouse button and drag the mouse to (15), and the application will respond automatically with a message describing the number of pixel calculated from the scale line, from (14) to (15). In one implementation, the application will highlight the scale with a different color when the operation is successful.

In the second step, the user enters the measurement (16) and the unit of measurement (17), using the following options:

1. Manually enter the measurement and the unit of measurement via a graphical application dialog screen.

2. The mouse pointer is moved to icon (20), the user defines the area where the measurement is located (21), and the user clicks on icon (22). This operation is repeated for the unit of measurement. After the user click on icon (22), the application will automatically recognize the measurement and unit of measurement by activating an OCR (Optical Character Recognition) function.

After the above steps, now the display screen is calibrated to calculate the dimensions of the image to be operated on. The horizontal ruler (18) and the vertical ruler (19) are calibrated with the measurement accordingly to the line scale on the image. These rulers display the scale properly accordingly to the user response to zoom in (23) or zoom out (24).

Now the user is ready to create all the graphical entities, generate dimensions or annotate the image. Calculating the dimensions on the graphical entities within a graphical application generally falls into three broad categories:

1. In the case of providing dimension operated directly on the image where graphical entities do not already existed. The following methods are used to calculate the dimension of the graphical entity:

a. To calculate the horizontal linear dimension, the user moves the mouse pointer to icon (30) and left-click on the mouse, move the mouse pointer to the first point (31) and left-click on the mouse, move the mouse pointer to where the dimension line (33) is placed, and left-click on the mouse. The graphical application automatically generates the proper dimension and annotation (32).

b. To calculate the vertical dimension, the user moves the mouse pointer to icon (40) and left-clicks on the mouse, moves the mouse pointer to the first point (41) and left-clicks on the mouse, and moves the mouse pointer to where the dimension line (43) is placed. The graphical application automatically generates the proper dimension and annotation

c. To calculate an aligned dimension, the dimension line is parallel to the line of origins of the two endpoints, the user moves the mouse pointer to icon (50) and left-click on the mouse, move the mouse pointer to the first point (51) and left-click on the mouse, and move the mouse pointer to where the dimension line (53) is placed. The graphical application automatically generates the proper dimension and annotation

d. To calculate the angular dimension, the user moves the mouse pointer to icon (60) and left-click the mouse, move the mouse to the angle vertex (62) and left-click the mouse, move the mouse to the first end point (61) and left-click the mouse, move the mouse to the second end point (63) and left-click the mouse, and move the mouse pointer to where the dimension line (64) is placed. The graphical application automatically generates the proper dimension and annotation.

e. To calculate the volume of solid object (sphere) represented in 2D in the image, the user moves the mouse pointer to (70) and left-click the mouse, move the mouse to end-points (73) and (74) to define the width, move the mouse to end-points (75) and (76) to define the height, and move the mouse pointer to where the dimension line (72) is placed. The graphical application automatically generates the proper dimension and annotation (71).

f. To calculate the volume of solid object like box (77), cylinder (79) or cone (78), the user uses the above technique in option (e) above to define the width and the height of the object. The graphical application automatically generates the proper dimension and annotation.

2. In the case of providing dimension where graphical entities are generated manually, using typical graphical drawing function like Paint of Microsoft Corporation, the user applies the drawing tool (80), and applies the dimension tool (82) to calculate and annotate the graphical entity drawn by the tool (80). The following illustrates the techniques:

a. To calculate the perimeter for a rectangle (83), the user moves the mouse pointer to icon (86) and left-clicks the mouse, moves the mouse pointer to the rectangle (83) or (84) and left-clicks the mouse, and moves the mouse pointer to where the dimension line (85) is placed. The graphical application automatically generates the proper dimension and annotation. This technique is applicable for the calculation of the dimension of a closed-polyline object (89) or an eclipse (89a).

b. To calculate the area for a rectangle (83), the user moves the mouse pointer to icon (87) and left-clicks the mouse, moves the mouse pointer to the rectangle (83) or (84) and left-clicks the mouse, and moves the mouse pointer to where the dimension line (88) is placed. The graphical application automatically generates the proper dimension and annotation. This technique is applicable for the calculation of the dimension of a closed-polyline object (89) or an eclipse (89a).

c. To calculate the circumference for a circle, the user moves the mouse pointer to icon (91a) and left-clicks the mouse, moves the mouse pointer to a point in the circle (92b) and left-clicks the mouse, and move the mouse pointer to where the dimension line (92a) is placed. The graphical application automatically generates the proper dimension and annotation.

d. To calculate the area for a circle, the user moves the mouse pointer to icon (91d) and left-clicks the mouse, moves the mouse pointer to a point in the circle (94b) and left-clicks the mouse, and moves the mouse pointer to where the dimension line (94a) is placed. The graphical application automatically generates the proper dimension and annotation.

e. To calculate the diameter for a circle, the user moves the mouse pointer to icon (91c) and left-clicks the mouse, moves the mouse pointer to a point in the circle (93a) and left-clicks the mouse, and moves the mouse pointer to where the dimension line (93b) is placed. The graphical application automatically generates the proper dimension and annotation.

f. To calculate the radius for a circle, the user moves the mouse pointer to icon (91b) and left-clicks the mouse, moves the mouse pointer to a point in the circle (95a) and left-clicks the mouse, and moves the mouse pointer to where the dimension line (95b) is placed. The graphical application automatically generates the proper dimension and annotation.

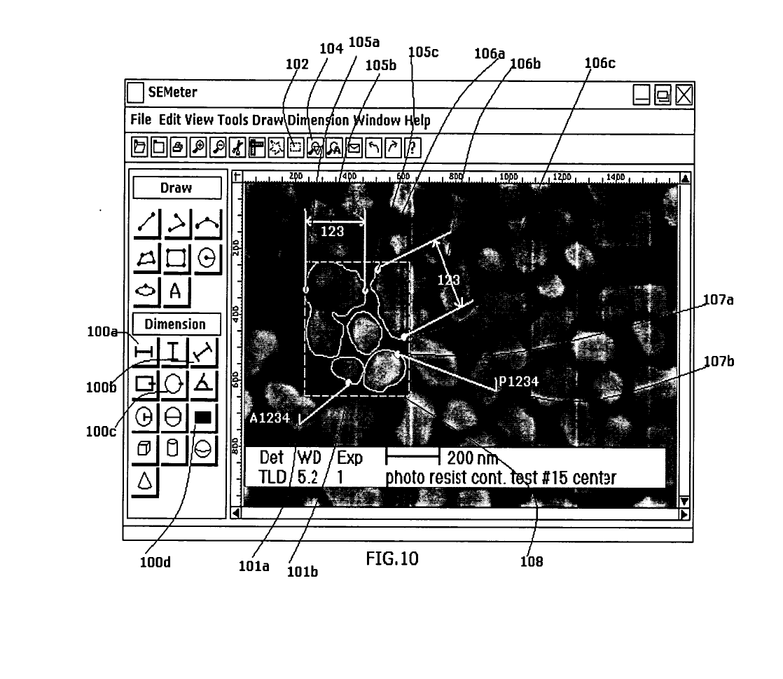

3. FIG. 10 shows an exemplary case of providing dimension where graphical entities are created automatically by the graphical application. The user moves the mouse pointer to the icon (102) and left-clicks on the mouse to define a box (109), the user moves the mouse pointer to icon (104) and left-clicks on the mouse, and the graphical application automatically recognizes or highlights the shape of the graphical entities within the defined box (108). After the shapes have been created by the application, the users can use the following techniques to create dimensions and annotations on the highlighted objects:

a. To calculate the perimeter of the object, the user moves the mouse pointer to icon (100c) and left-clicks the mouse, moves the mouse pointer to a point in the object (107a) and left-clicks the mouse, and moves the mouse pointer to where the dimension line (107b) is placed. The graphical application automatically generates the proper dimension and annotation.

b. To calculate the area of the object, the user moves the mouse pointer to icon (100d) and left-clicks the mouse, moves the mouse pointer to a point in the object (101b) and left-clicks the mouse, and moves the mouse pointer to where the dimension line (101a) is placed. The graphical application automatically generates the proper dimension and annotation.

c. To calculate the linear horizontal width of the object, the user moves the mouse pointer to icon (100a) and left-clicks the mouse, moves the mouse pointer to each end-point in the object (105a) (105c) and left-clicks the mouse, and moves the mouse pointer to where the dimension line (105b) is placed. The graphical application automatically generates the proper dimension and annotation. The user can repeat this technique for calculating the linear vertical length of the object.

d. To calculate the aligned width of the object, the user moves the mouse pointer to icon (100b) and left-click the mouse, moves the mouse pointer to each end-point in the object (106a) (106c) and left-clicks the mouse, and moves the mouse pointer to where the dimension line (106b) is placed. The graphical application automatically generates the proper dimension and annotation.

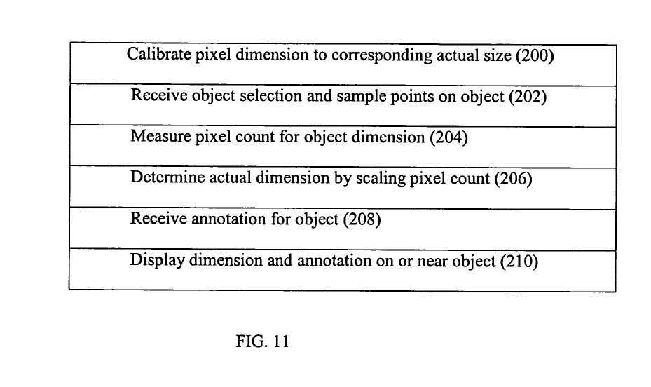

Referring now to FIG. 11, a process 200 for determining object dimension is illustrated. The process first calibrates pixel dimension to corresponding actual size (201). The process then receives an object selection and sample points on object (202). For example, in a manual selection embodiment, for a rectangle, the user indicates to the process that the object to be measured is a rectangle and specifies at least three points to define the rectangle. Alternatively, in an automatic selection embodiment, the user can point at an object and the process recognizes the shapes and locates points that define the object. Next, the process 200 measures pixel count for object dimension (204) and determines actual dimension by scaling the pixel count (206). Optionally, the process receives an annotation for the object (208). The process 200 then displays dimension and annotation data on or near the object (210).

For the manual selection embodiment in (202), the user cans specify two points in the picture or a valid shape object, and the system will automatically calculate the distance between them. For example, in the following picture, a vertical (or horizontal) dimension is specified using two points. Angular dimensions measure the angle between three points. The user cans measure dimension of an angle by specifying the angle vertex and 2 endpoints. Angular dimensions measure the angle between two lines. To measure the angle between two lines, the user selects two lines and then specifies the dimension location. As the users create the dimension, they can modify the text height and alignment before specifying the dimension location. In aligned dimension, the dimension line is parallel to the line of origins of the two endpoints. The users specify the two endpoints or click on the shape objects, and the system will automatically calculate and display the dimension in parallel to the original line. To calculate the perimeter of a closed polyline, the users specify the closed polyline object, and the system automatically calculates the perimeter. To calculate the circumference of a circle object, the users specify the object, and the system automatically calculates the circumference. To calculate the perimeter of a rectangle, the users specify the rectangle object, and the system automatically calculates the perimeter.

To calculate solid objects, the users specifies the height, the diameter (for cylinder, cone and sphere) and length and width for box, and the system automatically calculates the volume based the parameters input by the user. Since most solid objects are in 3D form, and the objects in SEM picture are in 2D plane, the system provides an approximate volume determination.

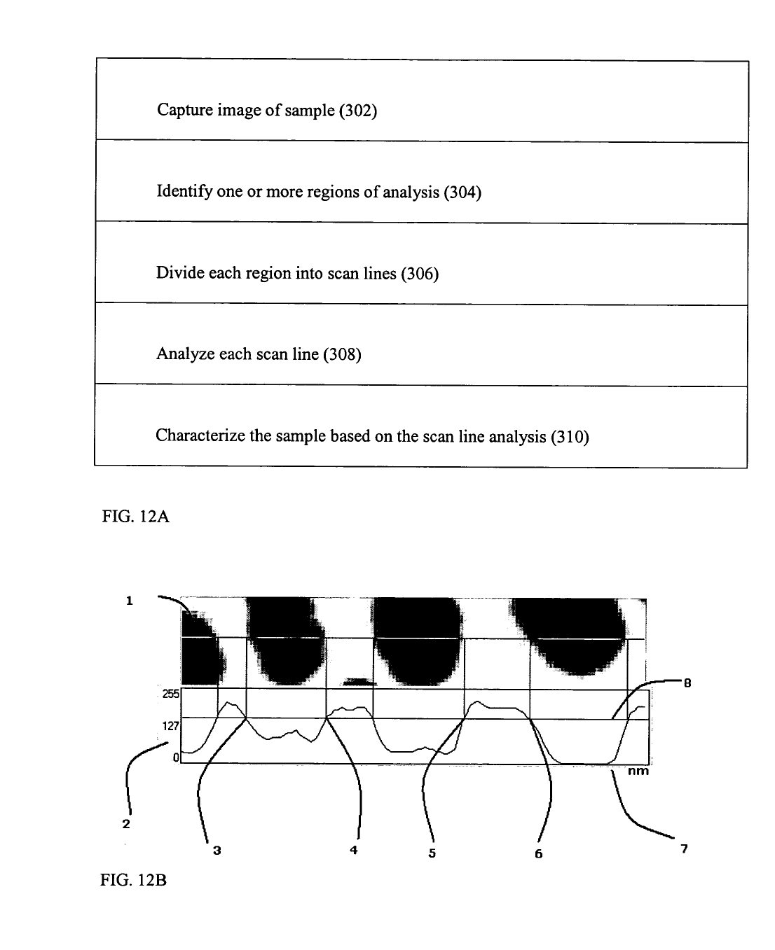

For the automatic selection embodiment in (202), the user defines an area in the SEM picture to be analyzed. The process automatically recognizes the object shape in the SEM picture, and these basic shapes will be active on the active window of the application. FIG. 12A illustrates an exemplary process 300 to automatically select and characterize dimensions of objects as discussed in (202). In this process, once the user has defined an area in the SEM picture to be analyzed, the process automatically recognizes the object shape in the SEM picture, and these basic shapes will be active on the active window of the application.

The method 300 acquires an image of the sample and calibrates the image using the scale bar (302). Images can be stored in JPEG, TIFF, GIF or BMP format, among others. Next, the method 300 identifies one or more regions of analysis (304). Each region in turn is divided into a plurality of scan lines (306). The method 300 then analyzes each scan line for objects, spots or grains (308) and characterizes the object based on the scan line analysis (310).

Pseudo-code for horizontal line analysis is as follows:

1. Horizontal lines are drawn in the specimen.

2. Each pixel on the line is converted to the gray scale value and store in a matrix corresponding to pixel's coordinate.

3. Pixel location intersect with line, depicting the average edge line.

4. The distance between and is the grain size on line.

5. The distance between the two boundaries is the empty space on line.

6. Line is the distance of line after spatial calibration.

7. Line is average edge line using average edge line detection.

Turning now to FIG. 12B, an example of the operation of the above pseudo-code is illustrated. First, horizontal lines (1) are drawn in the specimen. Next, each pixel on the line is converted to the gray scale value (2) and store in a matrix corresponding to pixel's coordinate. The pixel location (3) intersects with line (8), depicting the average edge line. The distance between (3) and (4) is the grain size on line (1). The distance between (5) and 6) is the empty space on line (2). The line (7) is the distance of line (1) after spatial calibration, while line (8) is average edge line using average edge line detection.

Alternatively, vertical line analysis can be done. Pseudo-code for horizontal line analysis is as follows:

1. Vertical lines are drawn in the specimen.

2. Each pixel on the line is converted to the gray scale value and store in a matrix corresponding to pixel's coordinate.

3. Pixel location intersect with line, depicting the average edge line.

4. The distance between and is the grain size on line.

5. The distance between the two boundaries is the empty space on line.

6. Line is the distance of line after spatial calibration.

7. Line is average edge line using average edge line detection.

In 308, each scan line image is converted into a grain's spatial attributes—perimeter, radius, area, x-vertices, y-vertices, among others. The analysis performed in 308 includes one or more of the following:

Area: The area of the object, measured as the number of pixels in the polygon. If spatial measurements have been calibrated for the image, then the measurement will be in the units of that calibration.

Perimeter: The length of the outside boundary of the object, again taking the spatial calibration into account.

Roundness: Computed as:

(4×PI×area)/perimeter²

The value will be between zero and one—The greater the value, the rounder the object. If the ratio is equal to 1, the object will a perfect circle, as the ratio decreases from one, the object departs from a circular form.

Elongation: The ratio of the length of the major axis to the length of the minor axis. The result is a value between 0 and 1. If the elongation is 1, the object is roughly circular or square. As the ratio decreases from 1, the object becomes more elongated.

Feret Diameter: The diameter of a circle having the same area as the object, it is computed as:

√(4×area/PI).

Compactness: Computed as:

√(4×area/PI)/major axis length

This provides a measure of the object's roundness. Basically the ratio of the feret diameter to the object's length, it will range between 0 and 1. At 1, the object is roughly circular. As the ratio decreases from 1, the object becomes less circular.

Major Axis Length: The length of the longest line that can be drawn through the object. The result will be in the units of the image's spatial calibration.

Major Axis Angle: The angle between the horizontal axis and the major axis, in degrees.

Minor Axis Length: The length of the longest line that can be drawn though the object perpendicular to the major axis, in the units of the image's spatial calibration.

Minor Axis Angle: The angle between the horizontal axis and the minor axis, in degrees.

Centroid: The center point (center of mass) of the object. It is computed as the average of the x and y coordinates of all of the pixels in the object.

Once the boundary of the object is detected using the above process, a shape recognition process determines the shape of the object as well as the points on the object that define the dimensions of the object. Such automatically measured dimensions are then scaled in accordance with the scale bar and the dimensional information is displayed.

In one embodiment, dimensional information for the object can be stored in tabular format, text delimited files, spreadsheet (Excel) files or database. Embodiments of the process can provide additional editing feature for the user to manually or automatically enhance these object shapes in the active window. Due to the resolution and noise on the SEM pictures, clean geometry shapes may not be created in the first pass, so the users are provided with additional tools to enhance the shapes to their preferences. Each single line segment can be edited separately. A line consists of two points in the picture. A polyline consists of a connected sequence of line as a single object. A closed polyline consists of a connected sequence of line as a single object with the same first and the last endpoint. The arc consists of 3 points—a start point, a second point on the arc, and an endpoint. A rectangle is drawn as a rectangle polyline. A circle is specified by a center and a radius. The shape of an ellipse is determined by two axes that define its length and width. The longer axis is called the major axis, and the shorter one is the minor axis.

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

Portions of the system and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The present invention has been described in terms of specific embodiments, which are illustrative of the invention and not to be construed as limiting. Other embodiments are within the scope of the following claims. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method to determine dimensions of an imaged object, comprising:
determining a scale factor for each pixel of the imaged object;
receiving two or more points associated with the object;
determining a pixel count between the two or more points; and
determining the actual dimension of the object using the pixel count and scale factor.

2. The method of claim 1, further comprising receiving user input for length, width, height, or shape of the object.

3. The method of claim 1, further comprising automatically determining length, width, height, or shape of the object.

4. The method of claim 1, further comprising automatically determining perimeter, angular or volume measurement calculation of the object in the image.

5. The method of claim 1, further comprising receiving annotation for the object.

6. The method of claim 1, wherein the at least one physical dimension is less than 100 nanometer.

7. The method of claim 1, further comprising capturing the image using SEM (Scanning Electron Microscopy).

8. The method of claim 1, further comprising automatically recognizing the object's geometry and calculating the object's dimensions.

9. The method of claim 8, further comprising:
a. identifying a region of analysis;
b. dividing the region into a plurality of scan lines
c. analyzing each scan line for objects, spots or grains; and
d. characterizing the object based on the scan line analysis.

10. A system to determine dimensions of an imaged object, comprising:
means for determining a scale factor for each pixel of the imaged object;
means for receiving two or more points associated with the object;
means for determining a pixel count between the two or more points; and
means for determining the actual dimension of the object using the pixel count and scale factor.

11. Apparatus including:
a display device coupled to information representative of an image, said image including features having at least one physical dimension of approximately 100 nanometers or less;
an input device capable of indicating one or more positions within a representation of said image on said display device;
a computing device coupled to said display device and to said input device, responsive to said one or more positions, and capable of calculating a dimension associated with a feature of said image, said feature being defined by said one or more positions.

12. Apparatus as in claim 11, wherein
said display device includes a set of pixels each representative of a portion of said image, each said pixel having a scale relative to said physical dimension;
at least one of said positions is associated with a pixel for said display device; and
at least one of (a) said physical dimension is responsive to a length defined in response to two said pixels, or (b) a line segment presentable on said display device is responsive to a value for said physical dimension.

13. Apparatus as in claim 11, wherein
said image includes a perspective representation of at least one feature having a three-dimensional volume, said three dimensional volume being defined in response to said one or more positions; and
at least one of
(a) said three-dimensional volume is responsive to an object represented by said image, said object being defined in response to said at one or more positions, wherein said object includes at least one of a bump, a gap, a hollow, a void, or a polysilicon or silicon crystal element;
(b) a representation of a three-dimensional volume is responsive to said one or more positions and a value for at least one said physical dimension, wherein said representation includes at least one of a box, a cone, a cylinder, or an ellipsoid or spheroid.

14. Apparatus as in claim 11, wherein
said image includes a perspective representation of at least one feature having a three-dimensional volume, said three-dimensional volume being defined in response to said one or more positions; and
said computing device, in response to said one or more positions, is capable of defining a set of boundaries associated with said feature, said boundaries being at least partially irregular, and in response thereto, is capable of calculating at least one physical dimension associated with said feature, said at least one physical dimension including an area, a perimeter, a surface area, or a volume.

15. Apparatus as in claim 11, wherein the computing device automatically determines length, width, height, or shape of the object.

16. Apparatus as in claim 11, wherein the computing device automatically determines perimeter, angular or volume measurement calculation of the object in the image.

17. Apparatus as in claim 11, wherein the computing device receives annotation for the object.

18. Apparatus as in claim 11, wherein the at least one physical dimension is less than 100 nanometer.

19. Apparatus as in claim 11, wherein the computing device captures the image using SEM (Scanning Electron Microscopy).

20. Apparatus as in claim 11, wherein the computing device automatically:
a. identify a region of analysis;
b. divide the region into a plurality of scan lines
c. analyze each scan line for objects, spots or grains; and
d. characterize the object based on the scan line analysis.
